(19) United States
(12) Patent Application Publication
(10) Pub. No.: US 2026/0002409 A1
(43) Pub. Date: Jan. 1, 2026

(54) LIGHT-ADJUSTING MOTOR FOR VENETIAN BLIND AND VENETIAN BLIND THEREOF

(71) Applicant: NINGBO SUNFREE MOTOR TECHNOLOGY COMPANY LIMITED, Ningbo City (CN)

(72) Inventor: Chun JIANG, Ningbo City (CN)

(21) Appl. No.: 18/884,089

(22) Filed: Sep. 12, 2024

(30) Foreign Application Priority Data
Jun. 30, 2024 (CN) 202421524669.6

(51) Int. Cl. E06B 9/322

(52) U.S. Cl. CPC E06B 9/322

(57) ABSTRACT

The present disclosure discloses a light-adjusting motor for a venetian blind and a venetian blind thereof which comprise a housing in which a motor, a battery and a control board are disposed. The motor and the battery are both electrically connected with the control board. The battery supplies power to the motor and the control board. The motor, the battery and the control board are disposed in parallel in the housing. An output end of the motor is connected with a transmission assembly for driving a light-adjusting rod. The transmission assembly comprises a first gear connected with the output end of the motor and a second gear connected with the light-adjusting rod. The first gear and the second gear are in meshed transmission. In this way, a conventional manual light-adjusting venetian blind is changed into an electric light-adjusting venetian blind, reducing the resource waste.

This application is based upon and claims priority to Chinese Patent Application No. 202421524669.6, filed on June 30^{th}, 2024, the entire contents of which are incorporated herein by reference.

### TECHNICAL FIELD

The present disclosure relates to the field of venetian blind technologies and in particular to a light-adjusting motor for a venetian blind and a venetian blind thereof.

### BACKGROUND

In the past, there were many manual venetian blinds on the market. During use, a light-adjusting rod is rotated manually to perform light blocking or light penetration adjustment on the venetian blinds. With the development of smart home, there emerge many electric venetian blinds on the market, which do not require manual operation for light adjustment, bringing operation conveniences and increasing popularity among consumers. If those original manual light-adjusting venetian blinds are replaced directly with the new electric venetian blinds, there will be many manual light-adjusting venetian blinds to be eliminated, resulting in much resource waste. In this case, it is urgent to find a solution to change the existing manual light-adjusting venetian blinds into a structure with electric light adjustment, which features small motor structure and fits into the original track assembling structure, so as to realize fast and convenient dismounting and replacement without resource waste.

### SUMMARY

For the above situations in the prior arts, the technical problem to be actually solved by the present disclosure is to provide a light-adjusting motor for a venetian blind and a venetian blind thereof, where the light-adjusting motor has the advantages of small structure and convenient replacement and assembling.

In order to solve the above technical problems, the present disclosure provides the following technical solution: there is provided a light-adjusting motor for a venetian blind, which comprises a housing in which a motor, a battery and a control board are disposed. The motor and the battery are both electrically connected with the control board. The battery supplies power to the motor and the control board. The motor, the battery and the control board are disposed in parallel in the housing. An output end of the motor is connected with a transmission assembly for driving a light-adjusting rod. The transmission assembly comprises a first gear connected with the output end of the motor and a second gear connected with the light-adjusting rod. The first gear and the second gear are in meshed transmission.

Furthermore, at least one transition gear is disposed between the first gear and the second gear.

Furthermore, a passage for the light-adjusting rod to run through is disposed in the housing. The passage is disposed in parallel to the motor, the battery and the control board. The second gear and the passage are in the same straight line.

Furthermore, the housing comprises a front cover, a rear cover and a housing body. The front cover and the rear cover are detachably connected with both ends of the housing body. A cavity is disposed in the housing body and penetrates through both ends along a length direction of the housing body.

Furthermore, the passage, the motor, the battery, and the control board are all disposed along the length direction of the housing. The motor and the battery are located at both sides of the passage respectively. The control board is located below the battery.

Furthermore, a switch key, a setup key and a power line electrically connected with the control board are exposed and arranged on the rear cover.

Furthermore, a line clamping position for limiting a running direction of the power line is further disposed on the rear cover.

Furthermore, an inwardly-recessed U-shaped groove for avoiding a transmission rod is disposed at a bottom of the housing. The U-shaped groove penetrates both ends along the length direction of the housing.

Furthermore, the battery is a lithium battery.

There is further provided a venetian blind, which comprises a top track in which a transmission rod, a transmission drive component, a light-adjusting rod, a light-adjusting drive component and rope winders are disposed. Louver blades are connected below the top track. The rope winders drive the louver blades to open and close up and down through corresponding winding ropes. The light-adjusting rod drives the louver blades to adjust light through corresponding rope ladders. The transmission drive component drives the transmission rod which then drives the rope winders to rotate. The light-adjusting drive component drives the rotation of the light-adjusting rod. The light-adjusting drive component is any one of the above light-adjusting motors.

Compared with the prior arts, the present disclosure has the following advantages: in the present disclosure, the motor, the battery and the control board are all integrated into the housing, and disposed in parallel, shortening the entire length and making the structure compact. Thus, the structure can be fitted to the top track of the existing manual light-adjusting venetian blind. The light-adjusting motor can be quickly inserted from the top of the top track into the top track and then clamped, and then the light-adjusting rod is inserted through the light-adjusting motor, so as to complete the assembling work, realizing small volume and quick assembling. In this way, a conventional manual light-adjusting venetian blind is changed into an electric light-adjusting venetian blind, reducing the resource waste.

### BRIEF DESCRIPTION OF THE DRAWINGS

In order to describe the embodiments of the present invention or the technical solution of the prior art more clearly, brief descriptions will be made below to the accompanying drawings involved in descriptions of the embodiments or the prior art. Obviously, the accompanying drawings are merely illustrative, and other drawings may also be obtained by those skilled in the art based on these drawings without paying creative work.

The structures, scales, sizes and the like depicted in the specification are only used by those skilled in the art to know and read the contents disclosed by the specification rather than to limit the embodiments of the present disclosure. Therefore, the structures, scales, sizes and the like do not have technically substantive meanings. Any modification, changes or adjustment to the structures, the scales and sizes shall all fall within the scope of protection covered by the technical contents disclosed by the present invention without affecting the effects and the purposes achieved by the present invention.

FIG. 1 is a structural schematic diagram of the present disclosure.

FIG. 2 is a sectional top view taken along a centerline of a passage according to the present disclosure.

FIG. 3 is a perspective schematic diagram of the FIG. 2.

FIG. 4 is a right-side sectional view of the present disclosure.

FIG. 5 is a left-side sectional view of a transmission assembly of the present disclosure.

FIG. 6 is a structural schematic diagram illustrating a venetian blind according to the present disclosure.

The numerals of the drawings are described below: 1. housing, 1.1 front cover, 1.2 rear cover, 1.3 housing body, 1.4 cavity, 1.5 passage, 1.6 line clamping position, 1.7 U-shaped groove, 2. motor, 3. battery, 4. control board, 5. first gear, 6. second gear, 7. transition gear, 8. switch key, 9. setup key, 10. power line, 11. top track, 12. transmission rod, 13. transmission drive component, 14. light-adjusting rod, 15. rope winder, 16. louver blade, 17. winding rope, 18. rope ladder.

### DETAILED DESCRIPTIONS OF EMBODIMENTS

The present invention will be further detailed below in combination with specific embodiments.

In the descriptions of the present invention, it is understood that orientation or positional relationship indicated by the terms such as “central”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, and “circumferential” is used only for ease of descriptions and simplification of descriptions and does not indicate or imply that the indicated devices or elements must have a particular orientation, or be constructed or operated in a particular orientation. Therefore, such terms shall not be understood as limiting of the present invention.

Further, the terms “first” and “second” are used for descriptions only and shall not be understood as indicating or implying relative importance or implicitly indicating the number of the indicated features. As a result, the features defined by “first” and “second” may explicitly or implicitly include at least one feature. In the descriptions of the present invention, the meaning of “several” refers to at least two, for example, two or three or the like, unless otherwise clearly stated.

In the present invention, unless otherwise clearly stated or defined, the terms “mount”, “connect”, “couple”, and “fix” and the like shall be understood in a broad sense, for example, may be fixed connection, or detachable connection, or formed into one piece; or may be mechanical connection, or electrical connection; or direct connection or indirect connection through an intermediate medium, or may be internal communication between two elements or mutual interaction of two elements, unless otherwise stated. Those skilled in the art may understand the specific meanings of the above terms in the present invention according to actual situations.

In the present invention, unless otherwise clearly stated or defined, the first feature being “on” or “below” the second feature refers to that the first feature and the second feature are in direct contact, or the first feature and the second feature are in indirect contact through an intermediate medium. Furthermore, the first feature being “above” or “on” the second feature refers to that the first feature is exactly above or obliquely above the second feature, or only refers to that the first feature has a higher horizontal height than the second feature. The first feature being “under” or “below” the second feature refers to that the first feature is exactly under or obliquely below the second feature, or only refers to that the first feature has a smaller horizontal height than the second feature.

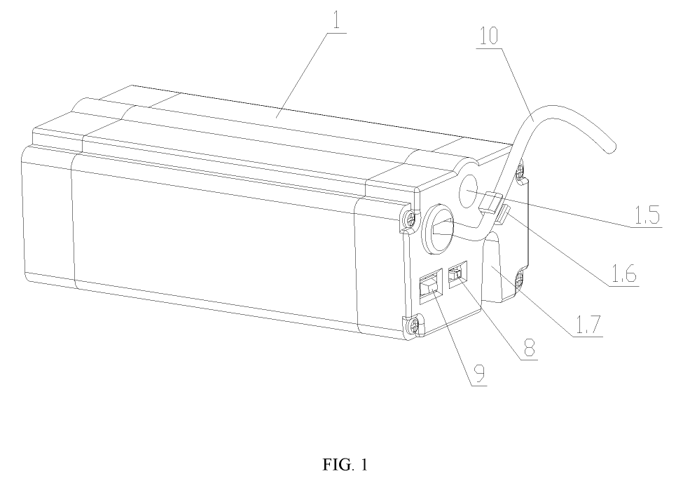

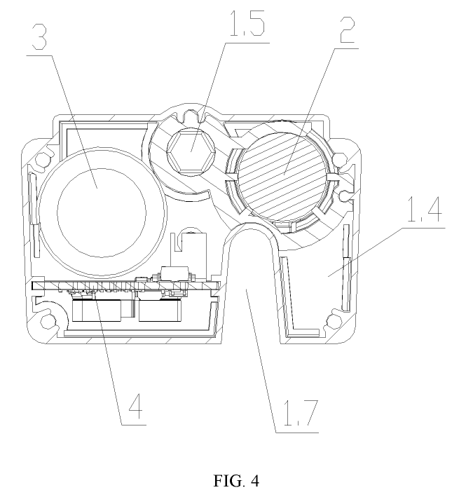

As shown in FIGS. 1 to 5, the present disclosure provides a light-adjusting motor for a venetian blind, which comprises a housing 1 in which a motor 2, a battery 3 and a control board 4 are disposed. The motor 2 and the battery 3 are both electrically connected with the control board 4. The battery 3 supplies power to the motor 2 and the control board 4. The motor 2, the battery 3 and the control board 4 are disposed in parallel in the housing 1. An output end of the motor 2 is connected with a transmission assembly for driving a light-adjusting rod 14. The transmission assembly comprises a first gear 5 connected with the output end of the motor 2 and a second gear 6 connected with the light-adjusting rod 14. The first gear 5 and the second gear 6 are in meshed transmission. The first gear 5 is sleeved on the output end of the motor 2 and can rotate in synchronization with the output end. A through hole for the light-adjusting rod 14 to run through is disposed in the second gear 6, where the through hole is matched in shape with a section of the light-adjusting rod 14. Thus, the motor 2 can drive the rotation of the first gear 5, the first gear 5 can drive the rotation of the second gear 6, and the second gear 6 can drive the rotation of the light-adjusting rod 14. The motor 2 is generally formed by assembling a motor core and a speed reducer.

In the present disclosure, the motor 2, the battery 3 and the control board 4 are all integrated into the housing 1, and disposed in parallel, shortening the entire length, making the structure compact, reducing the space occupation. Thus, the structure can be fitted to a top track 11 of the existing manual light-adjusting venetian blind. The light-adjusting motor can be quickly inserted from a top of the top track 11 into the top track 11 and then clamped, and then the light-adjusting rod 14 is inserted through the light-adjusting motor, so as to complete the assembling work, realizing small volume and quick assembling. In this way, a conventional manual light-adjusting venetian blind is changed into an electric light-adjusting venetian blind, reducing the resource waste.

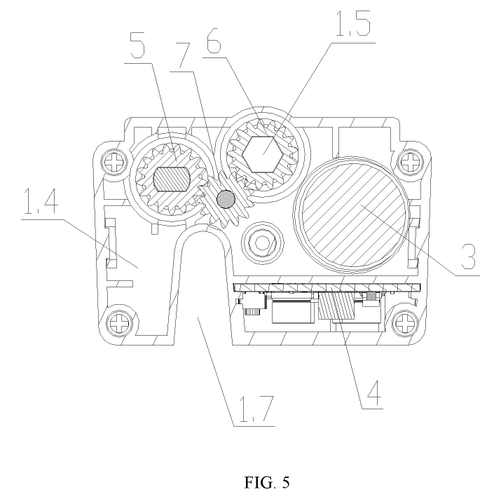

With reference to FIG. 5, at least one transition gear 7 is disposed between the first gear 5 and the second gear 6. When a distance between the first gear 5 and the second gear 6 is large, power transfer can be carried out by the transition gear 7, so as to realize the effect of assisting the transmission.

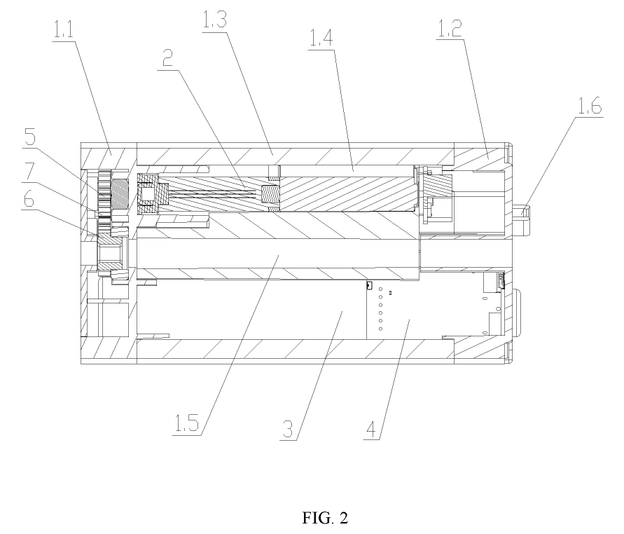

With reference to FIGS. 2, 3 and 4, a passage 1.5 for the light-adjusting rod 14 to run through is disposed in the housing 1. The passage 1.5 is disposed in parallel to the motor 2, the battery 3 and the control board 4. The second gear 6 and the passage 1.5 are in the same straight line to facilitate quick insertion of the light-adjusting rod 14. Further, the disposal of the passage 1.5 can prevent the light-adjusting rod 14 being inserted from colliding with other components in the housing 1, achieving the good protection effect and good guiding effect. In addition, due to parallel disposal of the passage 1.5, the motor 2, the battery 3 and the control board 4, high space utilization rate and compact structure can be achieved while the motor 2 can be helped to convey power in parallel to the light-adjusting rod 14.

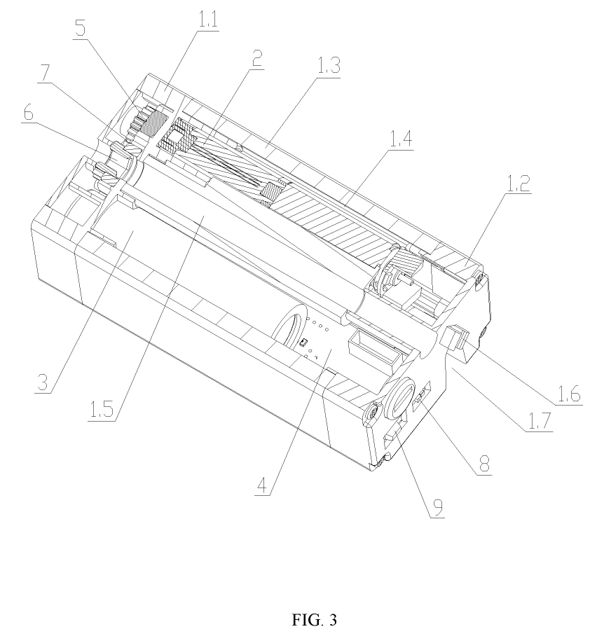

With reference to FIGS. 2 and 3, the housing 1 comprises a front cover 1.1, a rear cover 1.2 and a housing body 1.3. The front cover 1.1 and the rear cover 1.2 are detachably connected with both ends of the housing body 1.3. A cavity 1.4 is formed in the housing body 1.3 and penetrates through both ends along a length direction of the housing body 1.3. The disposal of the structure facilitates assembling and disassembling of the housing 1 as well as subsequent maintenance and inspection. The detachable connection may be buckling connection and screw connection and the like.

With reference to FIGS. 2, 3, 4 and 5, the passage 1.5, the motor 2, the battery 3, and the control board 4 are all disposed along the length direction of the housing 1. The motor 2 and the battery 3 are located at both sides of the passage 1.5 respectively. The control board 4 is located below the battery 3. The passage 1.5, the motor 2, the battery 3 and the control board 4 are disposed in parallel along the length direction of the housing 1 such that the entire length of the housing 1 is shortened. Further, the control board 4 is located in parallel below the battery 3. In this way, high space utilization rate and compact structure are achieved.

With reference to FIG. 1, a switch key 8, a setup key 9 and a power line 10 electrically connected with the control board 4 are exposed and arranged on the rear cover 1.2. The switch key 8 is used to turn on or off the light-adjusting motor, the setup key 9 is used for code matching, reversing and restoration of factory setting, and the power line 10 is used for power charge. A line clamping position 1.6 for limiting a running direction of the power line 10 is further disposed on the rear cover 1.2. The line clamping position 1.6 can clamp the power line 10 to prevent the random placement of the power line 10 from interfering with a transmission rod 12, and the light-adjusting rod 14 and the like in the top track 11, making the use safer.

With reference to FIGS. 1, 4, and 5, an inwardly-recessed U-shaped groove 1.7 for avoiding the transmission rod 12 is disposed at a bottom of the housing 1. The U-shaped groove 1.7 penetrates both ends along the length direction of the housing 1. When the light-adjusting motor is assembled to the top track 11, the disposal of the U-shaped groove 1.7 can avoid the transmission rod 12 in the top track 11, such that the light-adjusting motor does not press the transmission rod 12 while being inserted vertically into the top track 11, ensuring the normal operation of the transmission rod 12. The light-adjusting motor can be well fitted to the internal structure of the top track 11, bringing convenience to the assembling work.

The battery 3 is a lithium battery which can be charged and used without periodic change, bringing more use convenience.

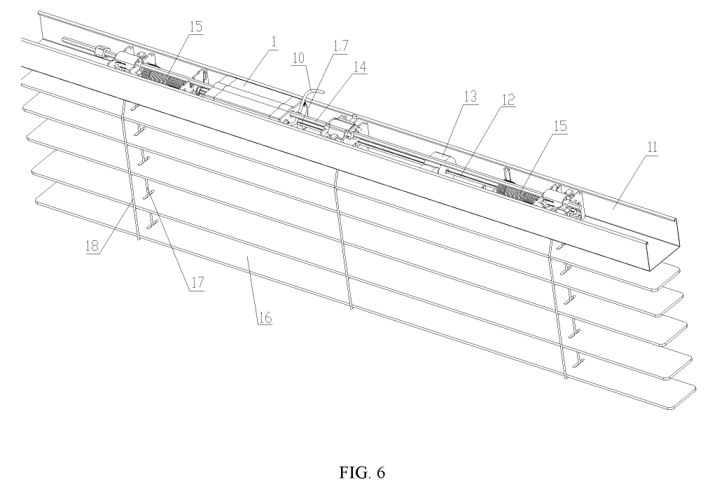

There is further provided a venetian blind. With reference to FIG. 6, the venetian blind comprises a top track 11. A transmission rod 12, a transmission drive component 13, a light-adjusting rod 14, a light-adjusting drive component and rope winders 15 are disposed in the top track 11. Louver blades 16 are connected below the top track 11. The rope winders 15 drive the louver blades 16 to open and close up and down through corresponding winding ropes 17. The light-adjusting rod 14 drives the louver blades 16 to adjust light through corresponding rope ladders 18. The transmission drive component 13 drives the transmission rod 12 which then drives the rope winders 15 to rotate. The light-adjusting drive component drives the rotation of the light-adjusting rod 14. The light-adjusting drive component is any one of the above light-adjusting motors.

During assembling process, the light-adjusting motor is vertically inserted from the top of the top track 11 while the rope winders 15 and the transmission drive component 13 are avoided. The U-shaped groove 1.7 on the light-adjusting motor is provided for the transmission rod 12 to be embedded so as to avoid the transmission rod 12, and then the light-adjusting rod 14 is inserted through the light-adjusting motor and specifically, the light-adjusting rod 14 runs through the passage 1.5 on the light-adjusting motor and at the same time, runs through the second gear 6. When the above two steps are completed, a manual light-adjusting venetian blind is changed into an electric light-adjusting venetian blind. When the light-adjusting motor works, the light-adjusting rod 14 is rotated to realize electric light adjustment. The light-adjusting motor features small entire volume and quick assembling and thus can change a conventional manual light-adjusting venetian blind into an electric light-adjusting venetian blind, reducing resource waste and satisfying the market requirements. In addition, it should be noted that the light-adjusting motor in the present disclosure is also applicable to a manual venetian blind in which the light-adjusting rod and the transmission rod belongs to the same structure. During change, the light-adjusting motor is also vertically inserted into the top track, and then the light-adjusting rod is inserted through the light-adjusting motor. The light-adjusting rod can not only drive the rope winders but also carry out light adjustment, so as to change a manual venetian blind into an electric venetian blind.

The materials, reagents and experimental instruments involved in the embodiments of the present disclosure are all commercially-available products in the technical field of venetian blinds, unless otherwise stated.

Finally, it is to be pointed out that the above embodiments are merely used to describe the technical solution of the present disclosure rather than limit the present disclosure. Although detailed descriptions are made to the present disclosure by referring to the preceding embodiments, those skilled in the art should understand that the technical solutions recorded in the above embodiments may be modified or part of technical features thereof may be equivalently substituted. Such modifications or substitutions will not cause the essences of the corresponding technical solutions to depart from the spirits and scopes of the technical solutions of various embodiments of the present disclosure.

1. A light-adjusting motor for a venetian blind, wherein the motor comprises a housing, and a motor, a battery and a control board are disposed the housing; the motor and the battery are both electrically connected with the control board; the battery supplies power to the motor and the control board; the motor, the battery and the control board are disposed in parallel in the housing; an output end of the motor is connected with a transmission assembly for driving a light-adjusting rod; the transmission assembly comprises a first gear connected with the output end of the motor and a second gear connected with the light-adjusting rod; the first gear and the second gear are in meshed transmission.

2. The light-adjusting motor for a venetian blind of claim 1, wherein at least one transition gear is disposed between the first gear and the second gear.

3. The light-adjusting motor for a venetian blind of claim 1, wherein a passage for the light-adjusting rod to run through is disposed in the housing; the passage is disposed in parallel to the motor, the battery and the control board; the second gear and the passage are in the same straight line.

4. The light-adjusting motor for a venetian blind of claim 3, wherein the housing comprises a front cover, a rear cover and a housing body; the front cover and the rear cover are detachably connected with both ends of the housing body; a cavity is disposed in the housing body and penetrates through both ends along a length direction of the housing body.

5. The light-adjusting motor for a venetian blind of claim 4, wherein the motor, the battery, and the control board are all disposed along the length direction of the housing; the motor and the battery are located at both sides of the passage respectively; the control board is located below the battery.

6. The light-adjusting motor for a venetian blind of claim 4, wherein a switch key, a setup key and a power line electrically connected with the control board are exposed and arranged on the rear cover.

7. The light-adjusting motor for a venetian blind of claim 6, wherein a line clamping position for limiting a running direction of the power line is further disposed on the rear cover.

8. The light-adjusting motor for a venetian blind of claim 1, wherein an inwardly-recessed U-shaped groove for avoiding a transmission rod is disposed at a bottom of the housing; the U-shaped groove penetrates both ends along the length direction of the housing.

9. The light-adjusting motor for a venetian blind of claim 1, wherein the battery is a lithium battery.

10. A venetian blind, comprising a top track, and a transmission rod, a transmission drive component, a light-adjusting rod, a light-adjusting drive component and rope winders are disposed inside the top track; louver blades are connected below the top track; the rope winders drive the louver blades to open and close up and down through corresponding winding ropes; the light-adjusting rod drives the louver blades to adjust light through corresponding rope ladders; the transmission drive component drives the transmission rod which then drives the rope winders to rotate; the light-adjusting drive component drives the rotation of the light-adjusting rod, wherein the light-adjusting drive component is the light-adjusting motor of claim 1.
